(19) United States
(12) Patent Application Publication
(10) Pub. No.: US 2021/0319344 A1
(43) Pub. Date: Oct. 14, 2021

(54) NATURAL LANGUAGE QUESTION ANSWERING

(71) Applicant: Microsoft Technology Licensing, LLC, Redmond, WA (US)

(72) Inventors: Duyu Tang, Beijing (CN); Nan Duan, Beijing (CN); Ming ZHOU, Beijing (CN)

(21) Appl. No.: 17/267,302

(22) PCT Filed: Jun. 20, 2019
(86) PCT No.: PCT/US2019/038071

§ 371 Date: Feb. 9, 2021

(30) Foreign Application Priority Data
Sep. 6, 2018 (CN) 201811038457.6

(51) Int. Cl. G06N 5/04; G06F 40/35; G06N 5/02; G06N 3/08; G06F 40/205

(52) U.S. Cl. CPC G06N 5/04; G06F 40/35; G06F 40/205; G06N 3/08; G06N 5/022

(57) ABSTRACT

In accordance with implementations of the present disclosure, there is provided a solution for answering a question in a natural language conversation. In this solution, a question in a natural language conversation is received and converted into a logical representation corresponding to semantics of the question, the logical representation including a first sequence of actions executable on a knowledge base. An answer to the question is derived by executing the first sequence of actions on the knowledge base. This solution can accurately understand the semantics of a question in a multi-round conversation, so as to convert the questions into a sequence of actions executable on a large-scale knowledge base. In this way, the solution can effectively improve accuracy and efficiency of the natural language question answering system in question answering.

### BACKGROUND

With the rapid development of computers and artificial intelligence technology, how to extract information that truly meets user needs from massive unstructured information has become an increasingly important research topic. Emerging at the right moment, Natural Language Question Answering (QA) system is a system which can accurately answer a question that a user describes in a natural language. Different from traditional search engines, the natural language question answering system understands true semantics of the user's question instead of simply matching keyword combinations. Because of the complex and varied vocabulary, grammar, and structure of a natural language, it is often difficult to understand the semantics of a natural language question. More than that, a large amount of short sentences and ellipsis may exist in a multi-round conversation, such that the true semantics of a current question can be accurately understood only in combination with the context of the multi-round conversation. All of these pose challenges to implementations of the natural language question answering system.

### SUMMARY

In accordance with implementations of the present disclosure, there is provided a solution for answering a question in a natural language conversation. In this solution, a question in a natural language conversation is received and converted into a logical representation corresponding to semantics of the question, the logical representation including a first sequence of actions executable on a knowledge base. An answer to the question is derived by executing the first sequence of actions on the knowledge base. This solution can accurately understand the semantics of a question in a multi-round conversation, so as to convert the questions into a sequence of actions executable on a large-scale knowledge base. In this way, the solution can effectively improve accuracy and efficiency of the natural language question answering system in question answering.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of a multi-round conversation;

FIG. 2 illustrates a block diagram of a computing environment where implementations of the present application can be implemented;

FIG. 3 illustrates a block diagram of a question-answering module for answering a question in a natural language conversation in accordance with implementations of the present disclosure;

FIG. 4 illustrates a schematic diagram of a semantic parsing tree in accordance with implementations of the present disclosure;

FIG. 5 illustrates a schematic diagram of a semantic parsing tree in accordance with implementations of the present disclosure;

FIG. 6 illustrates a schematic diagram of generating a sequence of actions corresponding to a question using an encoder-decoder model in accordance with implementations of the present disclosure;

FIG. 7 illustrates a schematic diagram of generating a sequence of actions corresponding to a question using an encoder-decoder model in accordance with implementations of the present disclosure; and

FIG. 8 illustrates a flowchart of a method for answering a question in a natural language conversation in accordance with implementations of the present disclosure.

Throughout the drawings, the same or similar reference symbols refer to the same or similar elements.

### DETAILED DESCRIPTION

The subject matter described herein will now be discussed with reference to several example implementations. It is to be understood these implementations are discussed only for the purpose of enabling those skilled persons in the art to better understand and thus implement the subject matter described herein, rather than suggesting any limitations on the scope of the subject matter.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, explicit and implicit, may be included below.

As used herein, the term “natural language” refers to an ordinary language of human beings for written communications or verbal communications. Examples of a natural language include Chinese, English, German, Spanish and French etc. In the following description, English will be taken as an example of the natural language. However, it should be understood that this is only for the purpose of illustration, without suggesting any limitation to the scope of the present disclosure. Embodiments of the present disclosure can be applicable to various natural languages.

As mentioned above, in order to accurately answer a question that a user describes in a natural language, it is required to understand true semantics of the user's question. Because of the complex and varied vocabulary, grammar, and structure of a natural language, it is often difficult to understand the semantics of a natural language question. More than that, a large amount of short sentences and ellipsis may exist in a multi-round conversation, which pose challenges to correctly understanding the semantics of the user's question.

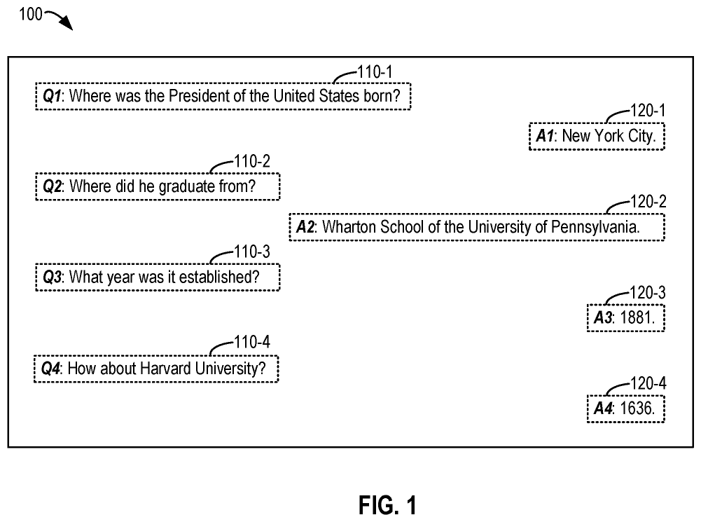

FIG. 1 illustrates a schematic diagram of a multi-round conversation 100. As used herein, a “multi-round conversation” represents a conversation including at least two rounds of questions and answers. As shown in FIG. 1, the multi-round conversation 100 includes four exemplary questions 110-1, 110-2, 110-3 and 110-4 (collectively referred to as questions 110 or individually referred to as question 110) and respective answers 120-1, 120-2, 120-3 and 120-4 (collectively referred to as answers 120 or individually referred to as answer 120). For example, the question 110-1 is “Where was the President of the United States born” and the answer 120-1 to that is “New York City.” The question 110-2 is “Where did he graduate from?” and the semantics of “he” is implicitly indicated by “the President of the United States” in the question 110-1. The answer 120-2 to the question 110-2 is “Wharton School of the University of Pennsylvania.” The question 110-3 is “What year was it established?” and the semantics of “it” is implicitly indicated by “Wharton School of the University of Pennsylvania” in the answer 120-2. The question 110-4 is “How about Harvard University?” and the semantics of this question is implicitly indicated by the question 110-3. That is, the question asked by the question 110-4 in fact is “What year was Harvard University established?”

In view of the above, it can be seen that, for a question in a multi-round conversation, the true semantics of the question can be accurately understood only in combination with the context (historical questions and/or historical answers). The correct answer to the question can be derived only if the semantics of the question in the natural language is correctly understood.

To answer a question in a natural language conversation, some traditional solutions train a neural network model using a group of questions and a group of answers directed to a finite dataset, so as to answer the natural language question of the user with the trained model. However, these solutions are only applicable to small-scale datasets. When the scale of the dataset is large, the overhead for training a model will be huge. Therefore, these solutions cannot accommodate the situation where the questions and the answers are diverse. Some other traditional solutions train a context-based semantic parser with a group of questions and a group of logical representations denoting respective semantics of the group of questions, so as to convert the natural language question of the user into a corresponding logical representation using the trained semantic parser. However, such solutions require accurately annotating the semantics of the questions in the training dataset in advance. That is, the solutions require that a logical representation for a certain question in the training dataset must be accurate and unique. Apparently, such solutions have a higher demand on the quality of the training dataset. When the scale of the training dataset is large, the overheads of data annotation will be huge.

Some problems existing in the traditional solutions of natural language question answering have been discussed above. In accordance with implementations of the present disclosure, there is provided a solution for answering a question in a natural language conversation, so as to solve the above problems and one or more of other potential problems. In this solution, a question in a natural language multi-round conversation is converted, by a trained neural network model, into a logical representation of semantics corresponding to the question, the logical representation including a sequence of actions executable on a large-scale knowledge base. An answer to the question can be derived by executing the sequence of actions on a large-scale knowledge base. The training dataset for training the model comprises a group of questions and respective answers to the group of questions without requiring accurate annotations of the logical representations of the questions in the training dataset in advance. The model executes semantic parsing on questions in a top-down manner following a predetermined grammar and stores in a data repository information related to the questions and respective answers as context information for understanding a subsequent question. When the semantics of the subsequent question depends on historical questions and/or historical answers, the model can copy corresponding contents from the data repository to generate a sequence of actions corresponding to the current question. In this way, the solution can accurately understand semantics of a question in a multi-round conversation, so as to effectively improve accuracy and efficiency of the natural language question answering system in question answering.

Various example implementations of the solution will be further described with reference to the drawings.

### Example Environment

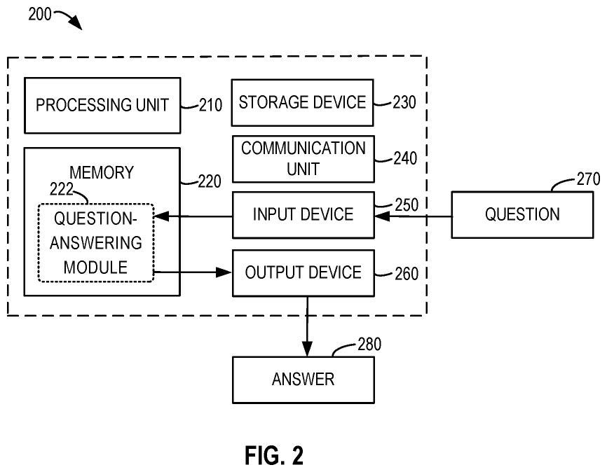

FIG. 2 illustrates a block diagram of a computing device 200 that can implement a plurality of implementations of the present disclosure. It should be understood that the computing device 200 shown in FIG. 2 is only exemplary, without suggesting any limitation to functions and the scope of the implementations of the present disclosure. According to FIG. 2, the computing device 200 includes a computing device 200 in the form of a general purpose computing device. Assemblies of the computing device 200 can include, but not limited to, one or more processors or processing units 210, memory 220, storage device 230, one or more communication units 240, one or more input devices 250 and one or more output devices 260.

In some implementations, the computing device 200 can be implemented as various user terminals or service terminals with computing power. The service terminals can be servers, large-scale computing devices and the like provided by a variety of service providers. The user terminal, for example, is mobile terminal, fixed terminal or portable terminal of any types, including mobile phone, site, unit, device, multimedia computer, multimedia tablet, Internet nodes, communicator, desktop computer, laptop computer, notebook computer, netbook computer, tablet computer, Personal Communication System (PCS) device, personal navigation device, Personal Digital Assistant (PDA), audio/video player, digital camera/video, positioning device, television receiver, radio broadcast receiver, electronic book device, gaming device or any other combinations thereof consisting of accessories and peripherals of these devices or any other combinations thereof. It can also be predicted that the computing device 200 can support any types of user-specific interfaces (such as “wearable” circuit and the like).

The processing unit 210 can be a physical or virtual processor and can execute various processing based on the programs stored in the memory 220. In a multi-processor system, a plurality of processing units executes computer-executable instructions in parallel to enhance parallel processing capability of the computing device 200. The processing unit 210 also can be known as central processing unit (CPU), microprocessor, controller and microcontroller.

The computing device 200 usually includes a plurality of computer storage media. Such media can be any attainable media accessible by the computing device 200, including but not limited to volatile and non-volatile media, removable and non-removable media. The memory 220 can be a volatile memory (e.g., register, cache, Random Access Memory (RAM)), a non-volatile memory (such as, Read-Only Memory (ROM), Electrically Erasable Programmable Read-Only Memory (EEPROM), flash), or any combinations thereof. The memory 220 can include a question-answering module 222 configured to execute functions of various implementations described herein. The question-answering module 222 can be accessed and operated by the processing unit 210 to perform corresponding functions.

The storage device 230 can be removable or non-removable medium, and can include machine readable medium, which can be used for storing information and/or data and can be accessed within the computing device 200. The computing device 200 can further include a further removable/non-removable, volatile/non-volatile storage medium. Although not shown in FIG. 2, there can be provided a disk drive for reading from or writing into a removable and non-volatile disk and an optical disk drive for reading from or writing into a removable and non-volatile optical disk. In such cases, each drive can be connected via one or more data medium interfaces to the bus (not shown).

The communication unit 240 implements communication with another computing device through communication media. Additionally, functions of assemblies of the computing device 200 can be realized by a single computing cluster or a plurality of computing machines, and these computing machines can communicate through communication connections. Therefore, the computing device 200 can be operated in a networked environment using a logic connection to one or more other servers, a Personal Computer (PC) or a further general network node.

The input device 250 can be one or more various input devices, such as mouse, keyboard, trackball, voice-input device and the like. The output device 260 can be one or more output devices, e.g., display, loudspeaker and printer etc. The computing device 200 also can communicate through the communication unit 240 with one or more external devices (not shown) as required, wherein the external device, e.g., storage device, display device etc., communicates with one or more devices that enable the users to interact with the computing device 200, or with any devices (such as network card, modem and the like) that enable the computing device 200 to communicate with one or more other computing devices. Such communication can be executed via Input/Output (I/O) interface (not shown).

The computing device 200 can provide services of natural language question answering in accordance with various implementations of the present disclosure. Accordingly, the computing device 200 sometimes is also referred to as “natural language question answering device 200” in the following text. While providing the services of natural language question answering, the computing device 200 can receive, via the input device 250, a natural language question 270. In some implementations, the question 270 can be a given individual question. Alternatively, in some further implementations, the question 270 can be a certain question (such as, one of the questions 110 shown in FIG. 1) in a multi-round conversation and its semantics may depend on a certain historical question or answer in the multi-round conversation. The computing device 200 can convert the question 270 into a logical representation corresponding to the semantics of the question 270, where the logical representation can include a sequence of actions executable on a large-scale knowledge base. The computing device 200 can execute the generated sequence of actions on the large-scale knowledge base, so as to derive an answer 280 to the question 270. Furthermore, the natural language question answering device 200 can store in the storage device 230 information on the question 270 and the answer 280 (including information on the generation of the sequence of actions) to serve as the context information for understanding a subsequent question in the multi-round conversation.

In some implementations, apart from being integrated on an individual device, some or all of the respective components of the computing device 200 also can be set in the form of cloud computing architecture. In the cloud computing architecture, these components can be remotely arranged and can cooperate to implement the functions described by the present disclosure. In some implementations, the cloud computing provides computation, software, data access and storage services without informing a terminal user of physical positions or configurations of systems or hardware providing such services. In various implementations, the cloud computing provides services via Wide Area Network (such as Internet) using a suitable protocol. For example, the cloud computing provider provides, via the Wide Area Network, the applications, which can be accessed through a web browser or any other computing assemblies. Software or assemblies of the cloud computing architecture and corresponding data can be stored on a server at a remote position. The computing resources in the cloud computing environment can be merged or spread at a remote datacenter. The cloud computing infrastructure can provide, via a shared datacenter, the services even though they are shown as a single access point for the user. Therefore, assemblies and functions described herein can be provided using the cloud computing architecture from a service provider at a remote position. Alternatively, assemblies and functions also can be provided from a conventional server, or they can be mounted on a client device directly or in other ways.

### Working Principle

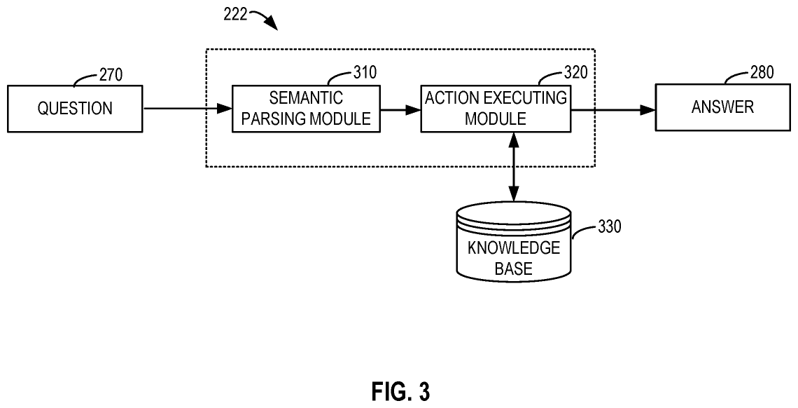

FIG. 3 illustrates a block diagram of a question-answering module 222 for answering a question in a natural language conversation in accordance with implementations of the present disclosure. The question-answering module 222 can be implemented in the computing device 200 of FIG. 2. As shown in FIG. 3, the question-answering module 222 can include a semantic parsing module 310 and an action executing module 320. The semantic parsing module 310 can receive a question 270 in a natural language conversation and parse the semantics of the question to generate a logical representation denoting the semantics of the question. For example, the logical representation can include a sequence of actions executable on a knowledge base 330. The action executing module 320 can receive the sequence of actions generated by the semantic parsing module 310. Furthermore, the action executing module 320 can execute the received sequence of actions on the knowledge base 330 and output an answer 280 to the question 270.

The knowledge base 330 shown in FIG. 3 can be any existing knowledge base or a knowledge base to be developed in the future. Examples of the knowledge base 330 may include, but not limited to, Freebase, DBpedia, YAGO, Open Information Extraction (Open 1E), Never-Ending Language Learning (NELL) and the like. “Knowledge Base (KB)” described herein is also known as “knowledge graph,” which can be provided for describing a variety of entities and concepts existing in the real world, the relations therebetween and their respective properties. As used herein, a “relation” refers to an association between two entities, e.g., the relation between Yao Ming and Ye Li is husband and wife. As used herein, a “property” refers to nature of an entity itself. By taking a person as an example, the properties of a person may include age, height, weight, gender and the like. A knowledge base is a set containing a large amount of knowledge. Examples of knowledge, for example, are “Yao Ming was born in Shanghai” and “Yao Ming is a basketball player” etc. For the sake of processing and understanding of the computer, the knowledge in the knowledge base can be represented in the form of a triple, such as, (first entity, relation, second entity). For example, the knowledge “Yao Ming was born in Shanghai” can be represented as a triple (Yao Ming, PlaceOfBirth, Shanghai). In the text, a relation (such as, PlaceOfBirth) also can be referred to as a “predicate.” If one entity is considered as a node and a relation (including a property and the like) between entities is considered as an edge, the knowledge base consisting of a large amount of triples forms a huge knowledge graph.

### Grammar of Semantic Parsing

In some implementations, the sematic parsing module 310 can execute semantic parsing on the question 270 in a top-down manner following a predetermined grammar, so as to generate a sequence of actions executable on the knowledge base 330. For example, Table 1 illustrates an example grammar in accordance with implementations of the present disclosure, which defines a series of actions executable on the knowledge base 330.

TABLE 1
Grammar of Semantic Parsing

| Action | Operation | Meaning |
|---|---|---|
| A1 | start→set | The question querying a set of entities |
| A2 | start→num | The question querying a number |
| A3 | start→bool | The question querying true or false |
| A4 | set→find(set1, r) | Finding a set of entities having a |
| | | relation r with the set of entities set1 |
| A5 | num→count(set1) | Determining the number of entities in |
| | | the set of entities set1 |
| A6 | bool→in(e, set1) | Determining whether the entity e exists |
| | | in the set of entities set1 |
| A7 | set→union(set1, | Deriving a union of entity sets set1 and |
| | set2) | set2 |
| A8 | set→inter(set1, set2) | Deriving an intersection of entity sets |
| | | set1 and set2 |
| A9 | set→diff(set1, set2) | Deriving a set of entities that are |
| | | included in the set of entities set1 but |
| | | not included in the set of entities set2 |
| A10 | set→ | Deriving a subset of the set of entities |
| | larger(set1, r, num) | set1, such that the subset links to more |
| | | than num entities with a relation r |
| A11 | set→less(set1, r, | Deriving a subset of the set of entities |
| | num) | set1, such that the subset links to less |
| | | than num entities with a relation r |
| A12 | set→equal(set1, r, | Deriving a subset of the set of entities |
| | num) | set1, such that the subset links to num |
| | | entities with a relation r |
| A13 | set→argmax(set1, r) | Deriving a subset of the set of entities |
| | | set1, such that the subset links to most |
| | | entities with a relation r |
| A14 | set→argmin(set1, r) | Deriving a subset of the set of entities |
| | | set1, such that the subset links to least |
| | | entities with a relation r |
| A15 | set→{e} | Deriving a set of entities including an |
| | | entity e |
| A16 | e→constant | Instantiating an entity e to a constant |
| A17 | r→constant | Instantiating a relation r to a constant |
| A18 | num→constant | Instantiating a number num to a |
| | | constant |
| A19 | set→sequence | Deriving a set of entities by replicating |
| | | a sequence of actions sequence |
| A20 | num→sequence | Deriving a number by replicating a |
| | | sequence of actions sequence |
| A21 | bool→sequence | Deriving true or false by replicating a |
| | | sequence of actions sequence |

As shown in Table 1, each action may include three parts: a semantic category, a function symbol (which might be omitted sometimes) and a list of arguments. For example, the semantic category can be one of start, set, num, true or false (bool). The semantic parsing on the question may usually start from the semantic category start. The function symbol indicates a specific action to be executed. Each of the list of arguments can be one of a semantic category, a constant or a sequence of actions. Taking the action A5 in Table 1 as an example, the action A5 has a semantic category num, a function symbol count and a semantic category set1 as the unique argument, the action A5 representing determining the number of entities in the set of entities set1.

It should be understood that the grammar shown in Table 1 is shown only for the purpose of illustration, without suggesting any limitation to the scope of the present disclosure. In some implementations, the grammar in Table 1 can be expanded to include more actions; or can be shrunk to omit some actions therein. In some further implementations, the sematic parsing can be performed based on a grammar that is different from the one shown in Table 1. The scope of the present disclosure is not limited in this regard. In the following text, the sematic parsing on the question will be described with reference to the grammar shown in Table 1.

In some implementations, the semantic parsing module 310 can perform semantic parsing on the question 270 in a top-down manner based on the grammar shown in Table 1, so as to generate a semantic parsing tree corresponding to the question 270. The semantic parsing module 310 can generate a sequence of actions representing the semantics of the question by traversing the semantic parsing tree corresponding to the question. The generation of the semantic parsing tree and the generation of the sequence of actions will be described in details below with reference to the question 110-1 (i.e., “Where was the President of the United States born?”) shown in FIG. 1.

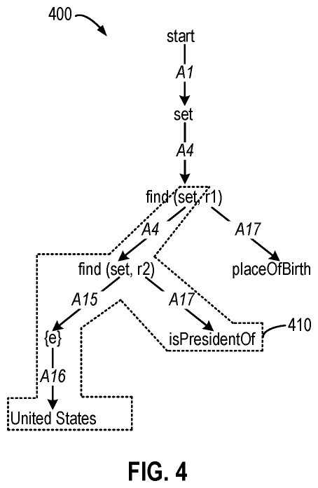

FIG. 4 illustrates a schematic diagram of a semantic parsing tree 400 corresponding to the question 110-1. A root node of the semantic parsing tree 400 is the semantic category start (hereinafter referred to as “S” for short). As the question 110-1 queries a place (i.e., a certain entity), a child node of the root node start is derived by applying the action A1. The child node of the root node start is an entity set (set) representing a place where the President of the United States was born. Because the birth place of the President of the United States represents a place having a certain relation (i.e., placeOfBirth) with “the President of the United States,” a child node find(set, r1) of the node set is further derived by applying the action A4. The set in the node find(set, r1) represents “the President of the United States” and the relation r1 indicates a relation with “the President of the United States.” Since “the President of the United States” represents a person who has a certain relation (i.e., isPresidentOf) with “the United States,” a child node find(set, r2) of the node find(set, r1) is further derived by applying the action A4. The set in the node find(set, r2) represents “the United States” and the relation r2 represents a relation with “the United States.” Because the set in the node find (set, r2) is an entity (i.e., “the United States”), its child node {e} is derived by applying the action A15 and then the entity e is instantiated to “the United States” by applying the action A16. In the following text, the action A16 which instantiates the entity e to “the United States” is also denoted as e_{US}. Furthermore, by applying the action A17, the relation r1 in the node find (set, r1) can be instantiated to placeOfBirth and the relation r2 in the node find (set, r2) can be instantiated to isPresidentOf. In the following text, the action A17 which instantiates the relation r1 to placeOfBirth is also denoted as r_{bth} and the action A17 which instantiates the relation r2 to isPresidentOf is also denoted as rₚᵣₑₛ. In this way, the semantic parsing tree 400 corresponding to the question 110-1 is generated. By performing depth-first traversal on the semantic parsing tree 400, the semantic parsing module 310 can generate a sequence of actions corresponding to the question 110-1, i.e., A1→A4→A4→A15→e_{US}→rₚᵣₑₛ→r_{bth}.

In some implementations, a subtree of the semantic parsing tree can correspond to a subsequence of the sequence of actions, which may represent a part of semantics of the question corresponding to the semantic parsing tree. For example, FIG. 4 illustrates a subtree 410 of the semantic parsing tree 400. The subtree 410 corresponds to a subsequence A4→A15→e_{US}→rₚᵣₑₛ of the sequence of actions A1→A4→A4→A15→e_{US}→rₚᵣₑₛ→r_{bt}, the subsequence representing a semantic unit “the President of the United States” in the question 110-1.

In some implementations, when the semantics of a subsequent question in the multi-round conversation depend on the semantics of a historical question, the semantic parsing module 310 may generate a semantic parsing tree corresponding to the subsequent question by replicating a subtree of a semantic parsing tree corresponding to the historical question, so as to generate a sequence of actions representing the semantics of the subsequent question. The generation of a semantic parsing tree and the generation of a sequence of actions in such scenario will be described in details below with reference to the question 110-2 (i.e., “Where did he graduate from?”) shown in FIG. 1.

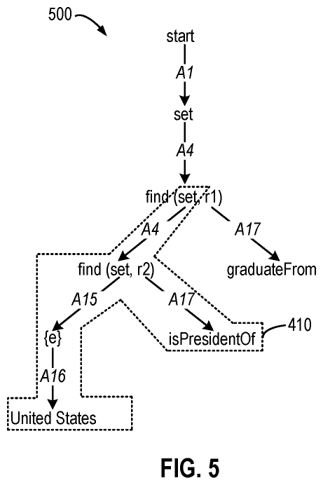

FIG. 5 illustrates a schematic diagram of a semantic parsing tree 500 corresponding to the question 110-2. Similar to the semantic parsing tree 400 shown in FIG. 4, the root node of the semantic parsing tree 500 is a semantic category start. As the question 110-2 queries a place (i.e., a certain entity), a child node of the root node start is derived by applying the action A1. The child node of the root node start is an entity set (set) representing “Where did he graduate from”. Because “Where did he graduate from” represents a place having a certain relation (i.e., graduateFrom) with “he,” a child node find(set, r1) of the node set is further derived by applying the action A4. The set in the node find(set, r1) represents “he” and the relation r1 indicates a relation with “he.” Since the semantics of “he” in the question 110-2 corresponds to a semantic unit “the President of the United States” in the question 110-1, the subtree 410 corresponding to “the President of the United States” in the semantic parsing tree 400 can be replicated into the semantic parsing tree 500, so as to represent “he” in the question 110-2. Then, the relation r1 in the node find(set, r1) is instantiated, by applying the action A17, to graduateFrom. In the following text, the action A17 which instantiates the relation r1 to graduateFrom is also denoted as r_{grad}. In this way, the semantic parsing tree 500 corresponding to the semantics of the question 110-2 is generated. By performing depth-first traversal on the semantic parsing tree 500, the semantic parsing module 310 can generate a sequence of actions corresponding to the question 110-2, i.e., A1→A4→A4→A15→e_{US}→rₚᵣₑₛ→r_{grad}.

### Model Implementations

In some implementations, the semantic parsing module 310 may perform semantic parsing on a question in the multi-round conversation using a trained neural network model. As used herein, a “model” can learn, from training data, respective associations between inputs and outputs during the training phase, so as to generate a corresponding output for a given input when the training phase is completed. For example, the neural network model is constructed to include a plurality of neurons, each neuron processing an input based on parameters obtained from the training and generating a corresponding output. The parameters of all neurons compose a set of parameters for the neural network model. When the set of parameters for the neural network model is determined, the model can be operated to perform corresponding functions. In the text, the terms “learning network,” “neural network,” “neural network model,” “model” and “network” can be used interchangeably.

In some implementations, the semantic parsing module 310 can employ a trained encoder-decoder model to implement semantic parsing on a question in the multi-round conversation. Typically, the encoder-decoder model may include one or more encoders and one or more decoders. An encoder may read source data, such as a sentence or an image, and then produce a feature representation in a continuous space. For example, an encoder of a Recurrent Neural Network (RNN) can take a sentence as an input and generate a vector of a fixed length corresponding to the meaning of the sentence. As another example, an encoder based on Convolutional Neural Network (CNN) can take an image as an input and generate data containing features of the image. The data generated by the encoder for characterizing the input features can be employed by the decoder to generate new data, such as a sentence in another language or an image in another form. The decoder is a generative model based on the features generated by the encoder. For example, a RNN decoder can learn and generate a representation in a further language for a sentence in a given language.

In some implementations, the semantic parsing module 310 can use a bidirectional RNN having Gated Recurrent Units (GRUs) as the encoder and a plurality of GRUs with attention mechanism as the decoder to implement the semantic parsing on a question in the multi-round conversation. A current question and its context (i.e., historical questions and historical answers) in the multi-round conversation can serve as an input of the encoder and can be represented as a sequence of words (also known as “source sequence”). During the operation of the encoder, a forward RNN can read the source sequence from left to right to obtain a first group of hidden states. For example, the first group of hidden states may represent preceding context of each word in the source sequence. In addition, a backward RNN can read the source sequence from right to left to obtain a second group of hidden states. For example, the second group of hidden states may represent following context of each word in the source sequence. A final hidden state representation of the source sequence can be derived by combining the first group of hidden states with the second group of hidden states, so as to act as an initial hidden state of the decoder. During the operation of the decoder, the decoder can generate a sequence of actions {a₁, a₂, . . . , a_{N}} corresponding to the current question sequentially, where N represents the number of actions in the sequence of actions.

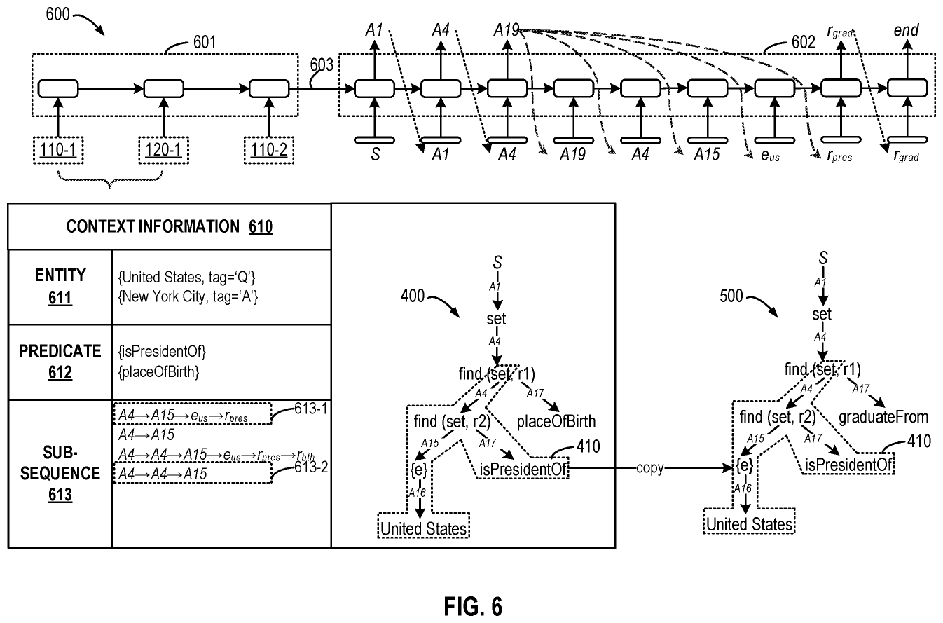

FIG. 6 illustrates a schematic diagram of generating a sequence of actions corresponding to the question using an encoder-decoder model in accordance with some implementations of the present disclosure. In FIG. 6, the question 110-2 shown in FIG. 1 is taken as an example for description and the question 110-2 depends on the historical question 110-1 and the historical answer 120-1.

As shown in FIG. 6, the historical question 110-1, the historical answer 120-1 and the current question 110-2 are input to the encoder 601, so as to obtain an initial hidden state 603 of the decoder 602. The decoder 602 generates a sequence of actions (e.g., corresponding to the semantic parsing tree 500) representing semantics of the question 110-2 sequentially. Specifically, the decoder 602 may output a distribution of grammar actions at each time step t. A context vector cₜ can be derived at the time step t using the attention mechanism. At each GRU, the concatenation of the context vector cₜ, the hidden state sₜ₋₁ obtained from the previous time step t−1 and an embedding layer vector representation vₜ₋₁ of an action predicted at the previous time step t−1 is fed to the GRU, so as to derive the current hidden state sₜ=GRU(sₜ₋₁,yₜ₋₁,cₜ), where if the previously predicted action is an instantiated action (i.e., one of A16-A18), the embedding layer vector representation is a vector representation of the selected constant.

In order to generate a valid sequence of actions, the decoder 602 may determine, based on an action-constrained grammar (such as, the grammar shown in Table 1), actions to be included in the sequence of actions. For example, if the semantic category of a given action in the grammar is the same as the semantic category of a leftmost nonleaf node of a partial semantic parsing tree which has been parsed, the given action can be selected as a suitable action. For example, the sequence of actions at the time step t is represented as Aₜ={a₁, a₂, . . . , a_{N}}, where N represents the number of actions included, so the probability distribution over the set can be determined according to the following equation (1):

$$p ( {a}_{i} \vert {a}_{< t} , x ) = \frac{exp ( {υ}_{i}^{T} {W}_{a} {s}_{t} )}{{\sum }_{{a}_{j} ∈ {A}_{t}} exp ( {υ}_{j}^{T} {W}_{a} {s}_{t} )} \qquad ( 1 )$$

where i∈[1, N]. a_{<t} represents a sequence of actions generated before the time step t. x represents the source sequence (i.e., the combination of historical question, historical answer and current question). vᵢ represents an embedding layer vector representation of the action aᵢ, which can be derived by performing one-hot encoding on the action aᵢ. Wₐ represents model parameter(s).

### Storage and Usage of Context Information

As described above, historical questions and historical answers are important for understanding the semantics of a subsequent question in the multi-round conversation. In some implementations, information on historical questions and historical answers can be stored as the context information for understanding semantics of a question in the multi-round conversation. In some implementations, in response to a part of semantics of the current question being implicitly indicated by a part of the context information, the decoder 602 can generate a sequence of actions corresponding to the current question by citing the part of the context information.

According to FIG. 6, the information related to the historical question 110-1 and the historical answer 120-1 is stored as the context information 610, which may include three types of information: information 611 (also referred to as “entity information”) about entities, information 612 (also referred to as “predicate information”) about predicates (i.e., relations) and information 613 (also referred to as “subsequence information”) about subsequences of the sequence of actions.

In some implementations, the entity information in the context information can record two types of entities, i.e., entities from historical questions and entities from historical answers. As shown in FIG. 6, the entity information 611 records the entity “United States” from the historical question 110-1 and is labeled with a tag “Q.” The entity information 611 also records the entity “New York City” from the historical question 120-1 and is labeled with a tag “A.” In some implementations, the predicate information in the context information can record predicates from the historical questions. As shown in FIG. 6, the predicate information 612 records the predicates isPresidentOf and placeOfBirth from the question 110-1.

In some implementations, the subsequence information in the context information may record one or more subsequences of the sequence of actions corresponding to the historical question. Each subsequence can be roughly categorized as an instantiated subsequence or a non-instantiated subsequence. An instantiated subsequence can convey complete or partial logical representation. For example, an instantiated subsequence can refer to a subsequence at least including one of actions A16-A18. A non-instantiated subsequence can convey a soft pattern of a logical representation. For example, a non-instantiated subsequence can refer to a subsequence excluding any one of actions A16-A18. As shown in FIG. 6, the subsequence information 613 records a plurality of subsequences of the sequence of actions (which corresponds to the semantic parsing tree 400) corresponding to the historical question 110-1, where each of the plurality of subsequences corresponds to a subtree of the semantic parsing tree 400. For example, the subsequence information 613 records an instantiated subsequence 613-1 and a non-instantiated subsequence 613-2.

In some implementations, in response to a part of semantics of the current question being implicitly indicated by a certain subsequence of the sequence of actions corresponding to the historical question, the decoder 602 may generate, by replicating the subsequence, a sequence of actions corresponding to the current question. The replicated subsequence can be an instantiated subsequence or a non-instantiated subsequence.

FIG. 6 illustrates an example of replication of an instantiated subsequence. As shown in FIG. 6, the subsequence information 613 records the instantiated subsequence 613-1, which corresponds to the subtree 410 of the semantic parsing tree 400 and represents “the President of the United States.” Since “he” in the current question 110-2 “Where did he graduate from” is implicitly indicated by “the President of the United States” in the question 110-1, the decoder 601, as shown in FIG. 6, generates an action A19 to replicate the subsequence 613-1 “A4→A15→eᵤₛ→rₚᵣₑₛ” into the sequence of actions corresponding to the current question 110-2.

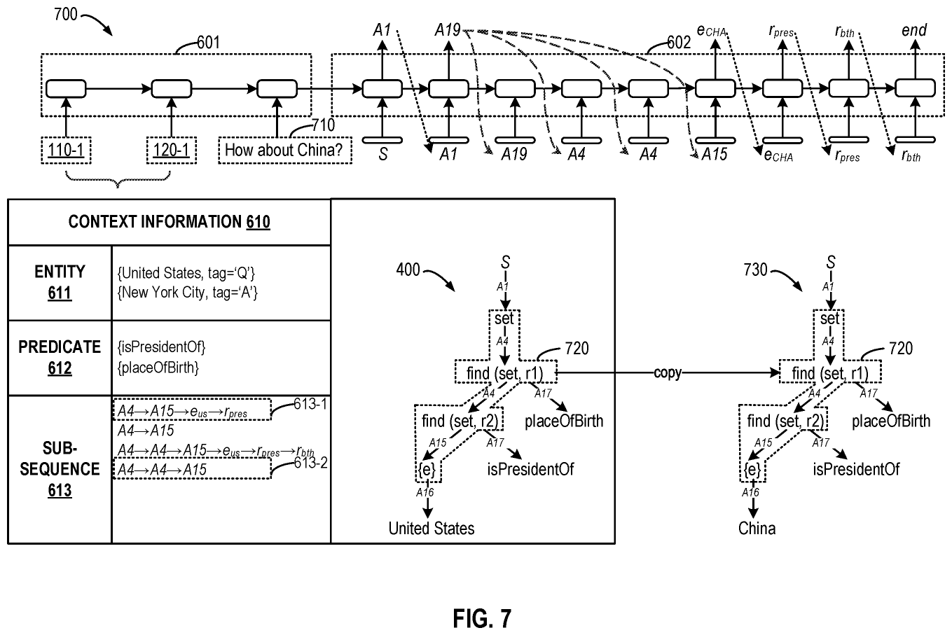

FIG. 7 illustrates an example of replication of a non-instantiated subsequence. For example, in FIG. 7, the historical question 110-1 and the historical answer 120-1 inputted to the encoder 601 are identical to the examples as shown in FIG. 6, while a current question 710 inputted to the encoder 601 is “How about China?” In such case, the context information still includes the entity information 611, the predicate information 612 and the subsequence information 613 as shown in FIG. 6, where the subsequence information 613 records a non-instantiated subsequence 613-2 “A4→A4→A15,” which represent the following semantics: querying a predicate associated with an entity, where the entity is derived from another action. For example, in FIG. 7, the question 710 has the same pattern as the historical question 110-1 and the difference therebetween is the entity “United States” in the historical question 110-1 is replaced by “China.” In such case, the decoder 602 can generate an action A19 to replicate the non-instantiated subsequence 613-2 “A4→A4→A15” into the sequence of actions corresponding to the current question 710. The subsequence 613-2 corresponds to a subtree 720 of the semantic parsing tree 400. The sequence of actions corresponding to the current question 710 may be generated by replicating the subsequence 613-2, which corresponds to the semantic parsing tree 730.

It can be seen from the above description that implementations of the present disclosure support replication of complete or partial logical representation. This is beneficial to the case when the entity in the current question is omitted, where the omitted entity may be indicated by a semantic unit in the historical question or by the historical answer. In addition, implementations of the present disclosure support replication of a soft pattern of the logical representation, which is beneficial when the current question has the same pattern as the historical question.

The strategies of the decoder while citing the contents from the context information will be further discussed below.

In some implementations, when the decoder instantiates an entity, a predicate or a number, an instantiation action (i.e., one of A16-A18) is permitted to access the context information. By taking entities as the example, each entity, according to its source, can have one of the following three tags: historical question, historical answer or current question. In some implementations, a probability that the entity et is instantiated at the time step t can be determined according to the following equation (2):

p(eₜ|a_{<t},x)=pₑ(eₜ|gₜ,a_{<t},x)p_{g}(gₜ|a_{<t},x) (2)

where p_{g}(⋅) represents a probability of the tag gₜ to be chosen and pₑ(⋅) represents a probability distribution over corresponding entities for each tag. The probability distribution of entities pₑ(⋅) can be determined according to the following equation (3):

$${p}_{e} ( {e}_{t} \vert {g}_{t} , {a}_{< t} , x ) = \frac{exp ( {υ}_{e}^{T} tanh ( {W}_{e} {s}_{t} ) )}{{\sum }_{{e}^{′} ∈ {E}_{gt}} exp ( {υ}_{{e}^{′}}^{T} tanh ( {W}_{e} {s}_{t} ) )} \qquad ( 3 )$$

where vₑ is the embedding of the entity eₜ; Wₑ is a model parameter; and E_{g}_{ₜ} is a set of entities having the tag gₜ. The probability p_{g}(⋅) is implemented by a linear layer followed by a softmax function.

In some implementations, when instantiating the entity eₜ at the time step t, the decoder may determine, based on the above probability, which of the entity information in the context information is to be used for instantiating the entity eₜ. Instantiations of predicates and numbers are similar to the instantiations of entities as described above, except that a predicate usually comes from a historical question or the current question only. Therefore, a predicate can have one of the following two tags: historical question and current question.

In some implementations, the decoder can select one of actions A19-A21 to replicate a certain subsequence of the sequence of actions corresponding to the historical question. The replication can have two patterns: replication of an instantiated subsequence and replication of a non-instantiated subsequence. For example, FIG. 6 illustrates an example of the replication of an instantiated subsequence, while FIG. 7 illustrates an example of the replication of a non-instantiated subsequence.

In some implementations, in order to determine the subsequence to be replicated, all of subtrees of a semantic parsing tree corresponding to the historical question can be obtained, where each subtree corresponds to a respective subsequence. Then, the decoder can determine a probability that the subsequence subₜ is to be replicated according to the following equation (4):

p(subₜ|a_{<t},x)=pₛ(subₜ|mₜ,a_{<t},x)pₘ(mₜ,a_{<t},x) (4)

where pₘ(⋅) represents a probability of a pattern mₜ to be chosen and pₛ(⋅) represents a probability distribution over subsequences for each pattern. The probability distribution over subsequences can be determined according to the following equation (5):

$${p}_{s} ( {sub}_{t} \vert {m}_{t} , {a}_{< t} , x ) = \frac{exp ( {υ}_{sub}^{T} tanh ( {W}_{s} {s}_{i} ) )}{{\sum }_{{s}_{i} ∈ {E}_{{m}_{t}}} exp ( {υ}_{si}^{T} tanh ( {W}_{s} {s}_{i} ) )} \qquad ( 5 )$$

where v_{sub} is the embedding of the subsequence subₜ and Eₘ_{ₜ} is a set of subsequences given a pattern mₜ. The embedding v_{sub} can be derived by encoding the subsequence subₜ using a GRU. The calculation of pₘ(⋅) is analogous to p_{g}(⋅).

In some implementations, the decoder may determine, based on the above probability, a subsequence subₜ to be replicated at the time step t. In some cases, if a wrong subsequence is replicated, it may cause error propagation, which further hurts the performance of the generation of the sequence of actions. Alternatively, in some implementations, the probability of an action to be chosen can be determined without replicating a subsequence, and a suitable action can be selected based on the probability, so as to generate the sequence of actions corresponding to the question.

### Model Training

In some implementations, the above model for semantic parsing on a question in a multi-round conversation can be trained based on a training dataset. For example, the training dataset may include a group of questions and respective answers to the group of questions without annotating an accurate logical representation for each question. In some implementations, in order to enable the trained model to perform semantic parsing on a question in a multi-round conversation, the training dataset may include a group of questions and respective answers to the group of questions, which are semantically dependent on each other. For example, the training dataset may at least include a first question and a first answer to the first question, and a second question and a second answer to the second question, wherein the semantics of the second question depends on at least one of the first question and the first answer.

In order to train the model, a corresponding sequence of actions can be generated for each training data (including one question and a correct answer to the question) in the training dataset. In some implementations, a breadth-first-search algorithm can be employed to generate a sequence of actions for each training data, such that a correct answer to a question can be obtained by executing the sequence of actions on a knowledge base (such as, the knowledge base 330). That is, implementations of the present disclosure do not require accurately annotating logical representations of questions in the training dataset in advance, thereby effectively reducing the overhead of the model training.

In some cases, the generated set of action sequences corresponding to a group of questions may include a redundant or invalid action sequence (e.g., a sequence of actions including an action of performing an union operation on two same entity sets). In some implementations, redundant or invalid sequences of actions can be pruned during the searching process. For example, before a complete sequence of actions for certain training data is generated, a partial sequence of actions, which may result into an invalid result, can be pruned in advance. For instance, an invalid result may be caused by an action find(e, r) in the following scenario: there is no entity in the knowledge base that is linked to the entity e via the relation r. In such case, a partial sequence of actions including find(e, r) can be pruned in advance. Additionally or alternatively, in some implementations, the sequences of actions can be pruned if all the arguments of an action are the same as each other (such as, union(set1, set2), where set1 is identical to set2). Additionally or alternatively, in some implementations, in order to shrink the search space, the maximum number of some actions (such as, union, argmax and larger) in the sequence of actions can be limited (such as, can be set as 1). Moreover, in some implementations, to cover the replication of subsequences, when a subsequence in the current sequence of actions corresponding to a given question (e.g., the second question as described above) is identical to a subsequence in the historical sequence of actions corresponding to its historical question (such as, the first question as described above), the subsequence in the current sequence of actions can be replaced by one of the replication actions A19-A21 shown in Table 1. In order to guarantee the quality of training instances with replication actions, some constraints can be set up, e.g., at least one instantiated constant of the two subsequences should be the same.

In some implementations, an objective function for training the model may be a sum of log probabilities of actions, instantiations, and subsequence replications, as shown in the following equation (6):

$$loss = - {\sum }_{t} log p ( {a}_{t} \vert {a}_{< t} , x ) - {\sum }_{t} δ ( ins , {a}_{t} ) log p ( {e}_{t} \vert {a}_{< t} , x ) - {\sum }_{t} δ ( rep , {a}_{t} ) log p ( {sub}_{t} \vert {a}_{< t} , x ) \qquad ( 6 )$$

where if the action aₜ is an instantiated action, δ(ins, aₜ) is 1; otherwise, δ(ins, aₜ) is 0. Similarly, if the action aₜ is a replication action, δ(rep, aₜ) is 1; otherwise, δ(rep, aₜ) is 0. Model parameters of the model for semantic parsing on a question in a multi-round conversation can be determined by minimizing the objective function shown in the above equation (6).

### Example Process

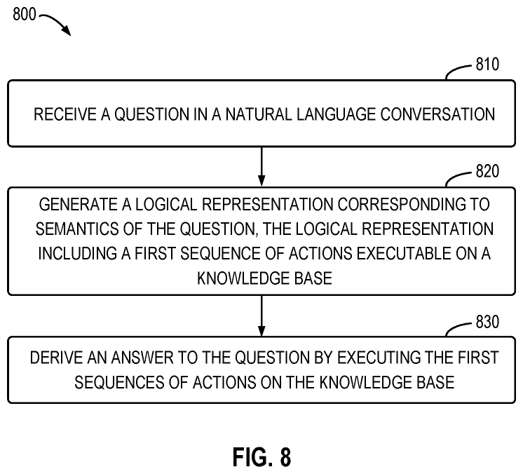

FIG. 8 illustrates a flowchart of a method 800 for answering a question in a natural language conversation in accordance with some implementations of the present disclosure. The method 800 can be implemented by the computing device 200, for example, implemented at the question-answering module 222 in the memory 220 of the computing device 200. At 810, the computing device 200 receives a question in a natural language conversation. At 820, the computing device 200 generates a logical representation corresponding to semantics of the question, the logical representation including a first sequence of actions executable on a knowledge base. At 830, the computing device 200 derives an answer to the question by executing the first sequences of actions on the knowledge base.

In some implementations, generating the logical representation comprises: generating a semantic parsing tree corresponding to the question by performing semantic parsing on the question in a top-down manner; and generating the first sequence of actions by traversing the semantic parsing tree.

In some implementations, generating the logical representation comprises: generating the first sequence of actions using a trained neural network model, wherein the neural network model is trained based on a training dataset, and the training dataset comprises a group of questions and respective answers to the group of questions.

In some implementations, the training dataset at least comprises a first question and a first answer to the first question, and a second question and a second answer to the second question, and semantics of the second question depends on at least one of the first question and the first answer.

In some implementations, the method 800 further comprises: recording first information on the question and the answer, the first information being used for understanding a subsequent question in the natural language conversation.

In some implementations, the first information comprises at least one of: an entity involved in the question; a predicate involved in the question; an entity involved in the answer; and; and one or more subsequences of the first sequence of actions, wherein each subsequence corresponds to a corresponding part of semantics of the question.

In some implementations, generating the logical representation comprises: in response to semantics of the question depending on at least one of a historical question and a historical answer in the natural language conversation, obtaining second information on the historical question and the historical answer; and generating the first sequence of actions at least based on the second information.

In some implementations, the second information comprises at least one of: an entity involved in the historical question; a predicate involved in the historical question; an entity involved in the historical answer; and one or more subsequences of a second sequence of actions corresponding to semantics of the historical question, wherein each subsequence corresponds to a corresponding part of semantics of the historical question.

In some implementations, generating the first sequence of actions at least based on the second information comprises: in response to determining that a part of semantics of the question is implicitly indicated by a part of the second information, generating the first sequence of actions by citing the part of the second information.

In some implementations, the second information comprises a subsequence of the second sequence of actions, and generating the first sequence of actions comprises: in response to determining that a part of semantics of the question corresponds to the subsequence of the second sequence of actions, generating the first sequence of actions by including the subsequence of the second sequence of actions into the first sequence of actions.

In view of the above, it can be seen that the solution for answering a question in a natural language conversation in accordance with implementations of the present disclosure converts, by a neural network model, a question in a natural language conversation into a logical representation of semantics corresponding to the question, the logical representation including a sequence of actions executable on a large-scale knowledge base. An answer to the question can be derived by executing the sequence of actions on a large-scale knowledge base. The training dataset for training the model comprises a group of questions and respective answers to the group of questions without requiring accurate annotations of the logical representations of the questions in the training dataset in advance. The model executes semantic parsing on questions in a top-down manner following a predetermined grammar and stores in a data repository information related to the questions and respective answers as context information for understanding a subsequent question. When the semantics of the subsequent question depends on historical questions and/or historical answers, the model can copy corresponding contents from the data repository to generate a sequence of actions corresponding to the current question. In this way, the solution can accurately understand semantics of a question in a multi-round conversation, so as to effectively improve accuracy and efficiency of the natural language question answering system in question answering.

### Example Implementations

Some example implementations of the present disclosure are listed below.

In one aspect, the present disclosure provides a compute-implemented method. The method comprises: receiving a question in a natural language conversation; generating a logical representation corresponding to semantics of the question, the logical representation including a first sequence of actions executable on a knowledge base; and deriving an answer to the question by executing the first sequences of actions on the knowledge base.

In some implementations generating the logical representation comprises: generating a semantic parsing tree corresponding to the question by performing semantic parsing on the question in a top-down manner; and generating the first sequence of actions by traversing the semantic parsing tree.

In some implementations, generating the logical representation comprises: generating the first sequence of actions using a trained neural network model, wherein the neural network model is trained based on a training dataset, and the training dataset comprises a group of questions and respective answers to the group of questions.

In some implementations, the training dataset at least comprises a first question and a first answer to the first question, and a second question and a second answer to the second question, and semantics of the second question depends on at least one of the first question and the first answer.

In some implementations, the method further comprises: recording first information on the question and the answer, the first information being used for understanding a subsequent question in the natural language conversation.

In some implementations, the first information comprises at least one of: an entity involved in the question; a predicate involved in the question; an entity involved in the answer; and one or more subsequences of the first sequence of actions, wherein each subsequence corresponds to a corresponding part of semantics of the question.

In some implementations, generating the logical representation comprises: in response to semantics of the question depending on at least one of a historical question and a historical answer in the natural language conversation, obtaining second information on the historical question and the historical answer; and generating the first sequence of actions at least based on the second information.

In some implementations, the second information comprises at least one of: an entity involved in the historical question; a predicate involved in the historical question; an entity involved in the historical answer; and one or more subsequences of a second sequence of actions corresponding to semantics of the historical question, wherein each subsequence corresponds to a corresponding part of semantics of the historical question.

In some implementations, generating the first sequence of actions at least based on the second information comprises: in response to determining that a part of semantics of the question is implicitly indicated by a part of the second information, generating the first sequence of actions by citing the part of the second information.

In some implementations, the second information comprises a subsequence of the second sequence of actions, and generating the first sequence of actions comprises: in response to determining that a part of semantics of the question corresponds to the subsequence of the second sequence of actions, generating the first sequence of actions by including the subsequence of the second sequence of actions into the first sequence of actions.

In another aspect, the present disclosure provides an electronic device. The electronic device comprises: a processing unit; and a memory coupled to the processing unit and including instructions stored thereon, the instructions, when executed by the processing unit, causing the device to perform actions comprising: receiving a question in a natural language conversation; generating a logical representation corresponding to semantics of the question, the logical representation including a first sequence of actions executable on a knowledge base; and deriving an answer to the question by executing the first sequences of actions on the knowledge base.

In some implementations generating the logical representation comprises: generating a semantic parsing tree corresponding to the question by performing semantic parsing on the question in a top-down manner; and generating the first sequence of actions by traversing the semantic parsing tree.

In some implementations, generating the logical representation comprises: generating the first sequence of actions using a trained neural network model, wherein the neural network model is trained based on a training dataset, and the training dataset comprises a group of questions and respective answers to the group of questions.

In some implementations, the training dataset at least comprises a first question and a first answer to the first question, and a second question and a second answer to the second question, and wherein semantics of the second question depends on at least one of the first question and the first answer.

In some implementations, the actions further comprise: recording first information on the question and the answer, the first information being used for understanding a subsequent question in the natural language conversation.

In some implementations, the first information comprises at least one of: an entity involved in the question; a predicate involved in the question; an entity involved in the answer; and one or more subsequences of the first sequence of actions, wherein each subsequence corresponds to a corresponding part of semantics of the question.

In some implementations, generating the logical representation comprises: in response to semantics of the question depending on at least one of a historical question and a historical answer in the natural language conversation, obtaining second information on the historical question and the historical answer; and generating the first sequence of actions at least based on the second information.

In some implementations, the second information comprises at least one of: an entity involved in the historical question; a predicate involved in the historical question; an entity involved in the historical answer; and one or more subsequences of a second sequence of actions corresponding to semantics of the historical question, wherein each subsequence corresponds to a corresponding part of semantics of the historical question.

In some implementations, generating the first sequence of actions at least based on the second information comprises: in response to determining that a part of semantics of the question is implicitly indicated by a part of the second information, generating the first sequence of actions by citing the part of the second information.

In some implementations, the second information comprises a subsequence of the second sequence of actions, and generating the first sequence of actions comprises: in response to determining that a part of semantics of the question corresponds to the subsequence of the second sequence of actions, generating the first sequence of actions by including the subsequence of the second sequence of actions into the first sequence of actions.

In a further aspect, the present disclosure provides a computer program product. The computer program product is tangibly stored in a computer storage medium and includes machine-executable instructions, the machine-executable instructions, when executed by a device, causing the device to perform the method in accordance with the above aspect.

In a further aspect, the present disclosure provides a computer-readable medium having machine-executable instructions stored thereon, the machine-executable instructions, when executed by a device, causing the device to perform the method in accordance with the above aspect.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, it should be understood that the operations are required to be executed in the shown particular order or in a sequential order, or all shown operations are required to be executed to achieve the expected results. In certain circumstances, multitasking and parallel processing may be advantageous. Likewise, while several specific implementation details are contained in the above discussions, these should not be construed as limitations on the scope of the subject matter described herein. Certain features that are described in the context of separate implementations may also be implemented in combination in a single implementation. Conversely, various features that are described in the context of a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method, comprising:
receiving a question in a natural language conversation;
generating a logical representation corresponding to semantics of the question, the logical representation including a first sequence of actions executable on a knowledge base; and
deriving an answer to the question by executing the first sequences of actions on the knowledge base.

2. The method of claim 1, wherein generating the logical representation comprises:
generating a semantic parsing tree corresponding to the question by performing semantic parsing on the question in a top-down manner; and
generating the first sequence of actions by traversing the semantic parsing tree.

3. The method of claim 1, wherein generating the logical representation comprises:
generating the first sequence of actions using a trained neural network model,
wherein the neural network model is trained based on a training dataset, and the training dataset comprises a group of questions and respective answers to the group of questions.

4. The method of claim 3, wherein the training dataset at least comprises a first question and a first answer to the first question, and a second question and a second answer to the second question, and wherein semantics of the second question depends on at least one of the first question and the first answer.

5. The method of claim 1, further comprising:
recording first information on the question and the answer, the first information being used for understanding a subsequent question in the natural language conversation.

6. The method of claim 5, wherein the first information comprises at least one of:
an entity involved in the question;
a predicate involved in the question;
an entity involved in the answer; and
one or more subsequences of the first sequence of actions, wherein each subsequence corresponds to a corresponding part of semantics of the question.

7. The method of claim 1, wherein generating the logical representation comprises:
in response to semantics of the question depending on at least one of a historical question and a historical answer in the natural language conversation, obtaining second information on the historical question and the historical answer; and
generating the first sequence of actions at least based on the second information.

8. The method of claim 7, wherein the second information comprises at least one of:
an entity involved in the historical question;
a predicate involved in the historical question;
an entity involved in the historical answer; and
one or more subsequences of a second sequence of actions corresponding to semantics of the historical question, wherein each subsequence corresponds to a corresponding part of semantics of the historical question.

9. The method of claim 8, wherein generating the first sequence of actions at least based on the second information comprises:
in response to determining that a part of semantics of the question is implicitly indicated by a part of the second information, generating the first sequence of actions by citing the part of the second information.

10. The method of claim 9, wherein the second information comprises a subsequence of the second sequence of actions, and generating the first sequence of actions comprises:
in response to determining that a part of semantics of the question corresponds to the subsequence of the second sequence of actions, generating the first sequence of actions by including the subsequence of the second sequence of actions into the first sequence of actions.

11. An electronic device, comprising:
a processing unit; and
a memory coupled to the processing unit and including instructions stored thereon, the instructions, when executed by the processing unit, causing the device to perform actions comprising:
receiving a question in a natural language conversation;
generating a logical representation corresponding to semantics of the question, the logical representation including a first sequence of actions executable on a knowledge base; and
deriving an answer to the question by executing the first sequences of actions on the knowledge base.

12. The device of claim 11, wherein generating the logical representation comprises:
generating a semantic parsing tree corresponding to the question by performing semantic parsing on the question in a top-down manner; and
generating the first sequence of actions by traversing the semantic parsing tree.

13. The device of claim 11, wherein generating the logical representation comprises:
generating the first sequence of actions using a trained neural network model,
wherein the neural network model is trained based on a training dataset, and the training dataset comprises a group of questions and respective answers to the group of questions.

14. The device of claim 13, wherein the training dataset at least comprises a first question and a first answer to the first question, and a second question and a second answer to the second question, and wherein semantics of the second question depends on at least one of the first question and the first answer.

15. A computer program product tangibly stored in a computer storage medium and including machine-executable instructions, the machine-executable instructions, when executed by a device, causing the device to perform actions comprising:
receiving a question in a natural language conversation;
generating a logical representation corresponding to semantics of the question, the logical representation including a first sequence of actions executable on a knowledge base; and
deriving an answer to the question by executing the first sequences of actions on the knowledge base.
